(19) United States
(12) Patent Application Publication
(10) Pub. No.: US 2026/0203358 A1
(43) Pub. Date: Jul. 16, 2026

(54) Personalized Search with URL Keyword Links

(71) Applicant: Glean Technologies, Inc., Palo Alto, CA (US)

(72) Inventors: Arjun Landes, San Francisco, CA (US); Shivaal Kaul Roy, Stanford, CA (US); Jerry Huang, Herndon, CA (US); Piyush Prahladka, Los Altos, CA (US); Cindy Chang, Mountain View, CA (US); Alan Tzi-Hong Yiu, Dublin, CA (US); Rachel Li, San Francisco, CA (US); Pancham Yadav, San Mateo, CA (US); Mustafa Murat Tikir, Sunnyvale, CA (US); Sagar Vare, Mountain View, CA (US); Rick Huang, Seattle, WA (US); Nathan Arritt, Palo Alto, CA (US); Amy Liu, San Francisco, CA (US); Samarth Aggarwal, Mountain View, CA (US); Dorothy Kang, Palo Alto, CA (US); Aditya Singh, Palo Alto, CA (US); Omar Nabi Khan, Mountain View, CA (US); Nikhil Mandava, Fremont, CA (US)

(21) Appl. No.: 19/019,219

(22) Filed: Jan. 13, 2025

(51) Int. Cl. G06F 16/93; G06F 16/955

(52) U.S. Cl. CPC G06F 16/94; G06F 16/955

(57) ABSTRACT

Methods and apparatuses for automatically generating and displaying clustered search results and contextual recommendations are described. While a user is making edits to an electronic document or within an application, a search system may identify a set of search terms based on information entered by the user and/or the locations of the information entered by the user within the electronic document or application and then generate and display search results based on the set of search terms. The search system may cluster search result documents that have a degree of similarity and display multiple clusters of search results to the user. The search system may allow users to specify personalized keyword links and may return a personalized keyword link as a search result for a given search query even if a document or resource referenced by the keyword link has not been indexed or crawled.

### BACKGROUND

Members of an organization may be granted restricted access to data (e.g., electronic documents) that is stored across various data repositories and data stores, such as enterprise databases and cloud-based data storage services. The data may comprise unstructured data or structured data (e.g., the data may be stored within a relational database). A search engine may allow the data to be indexed, searched, and displayed to authorized users that have permission to access or view the data. A user of the search engine may provide a textual search query to the search engine and in return the search engine may display the most relevant search results for the search query as links to electronic documents, web pages, electronic messages, images, videos, and other digital content. To determine the most relevant search results, the search engine may search for relevant information within a search index for the data and then score and rank the relevant information. In some cases, an electronic document indexed by the search engine may have an associated access control list (ACL) that includes access control entries that identify the access rights that the user has to the electronic document. The most relevant search results for the search query that are displayed to the user may comprise links to electronic documents and other digital content that the user is authorized to access in accordance with access control lists for the underlying electronic documents and other digital content.

### BRIEF SUMMARY

Systems and methods are provided for automatically generating and displaying clustered search results and contextual recommendations. The contextual recommendations may provide both supplemental content and supplemental context related to an electronic document or application into which a user is inserting content or information without requiring the user to initiate an explicit search (e.g., via submission of a search query). While the user is making edits to an electronic document or within an application in real-time, a search system may identify a set of search terms based on information entered by the user and/or the locations of the information entered by the user within the electronic document or application and then generate and display search results based on the set of search terms. The search system may generate and display the contextual recommendations in response to a search triggering event. The search system may cluster search results or search result documents that have a degree of similarity and display multiple clusters of search results to the user. The results within a cluster of search results may be ranked and/or ordered based on document search rankings, the last edit dates for the search results in the cluster, and/or the creation dates of documents associated with the search results in the cluster. A summary of the contents within the search results of a cluster may be generated using a generative model and the summary may be displayed along with links to a subset of the search results within the cluster.

Systems and method are also provided for allowing users of the search system to specify and use personalized Uniform Resource Locator (URL) keyword links to access computing devices, services, and documents. A URL keyword link may be used to map a long and complicated URL into one or more shorter and easier to remember keywords. The search system may return URL keyword links as search results for a given search query even if a document or resource referenced by the URL keyword link has not been indexed or crawled. To identify an appropriate URL keyword link as a search result, the search system make take into consideration a username associated with a user entering a search query, the text used for the URL keyword link itself, the text used as context around the URL keyword link if the URL keyword link was referenced in a chat message or electronic document, the text used in the URL string that the keyword link maps to, and/or the text used by other URL keyword links that map to the same URL string as the URL keyword link.

According to some embodiments, the technical benefits of the systems and methods disclosed herein include reduced energy consumption and cost of computing resources, increased quality of search results, increased reliability of information provided to search users, and improved search system performance.

This Summary is provided to introduce a brief description of some aspects of the disclosed technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

Like-numbered elements may refer to common components in the different figures.

FIG. 1 depicts one embodiment of a networked computing environment.

FIG. 2A depicts one embodiment of a search and knowledge management system in communication with one or more data sources.

FIG. 2B depicts one embodiment of the search and knowledge management system of FIG. 2A.

FIG. 2C depicts one embodiment of various components of the search and knowledge management system of FIG. 2A.

FIGS. 3A-3C depict various embodiments of a mobile device providing a user interface for interacting with a permissions-aware search and knowledge management system.

FIG. 4A depicts a flowchart describing one embodiment of a process for generating contextual recommendations that include clustered search results.

FIG. 4B depicts a flowchart describing one embodiment of a process for generating clustered search results.

FIG. 4C depicts a flowchart describing one embodiment of a process for automatically generating and displaying clustered search results and contextual recommendations.

FIG. 5 depicts one embodiment of a mobile device providing a user interface for interacting with a permissions-aware search and knowledge management system to create, store, and utilize keyword link and URL string pairs.

FIG. 6A depicts a flowchart describing one embodiment of a process for generating and storing keyword link and URL string pairs.

FIG. 6B depicts a flowchart describing one embodiment of a process for utilizing keyword link and URL string pairs.

FIG. 6C depicts a flowchart describing one embodiment of a process for generating and displaying a keyword link as a search result.

### DETAILED DESCRIPTION

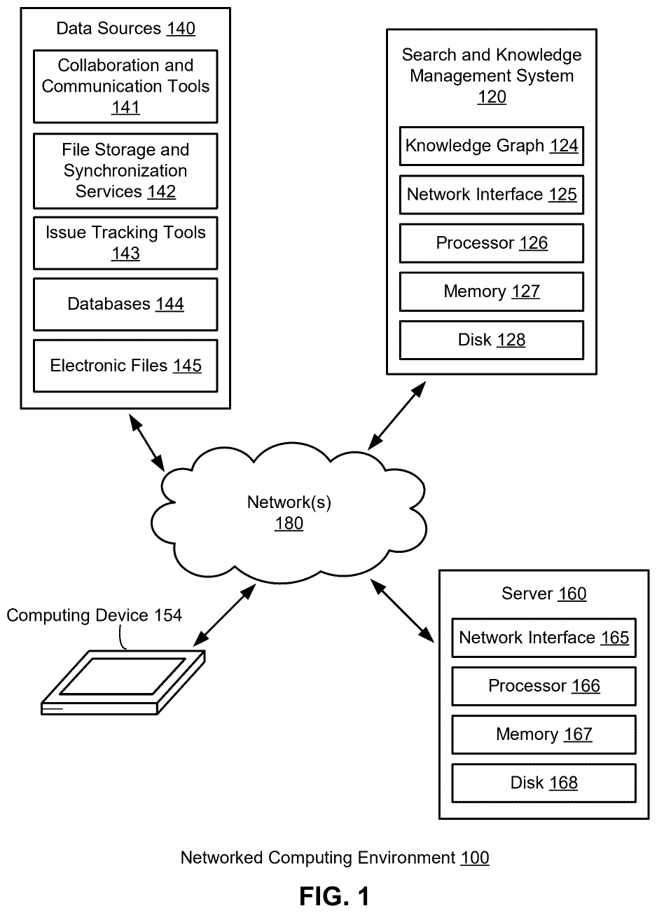

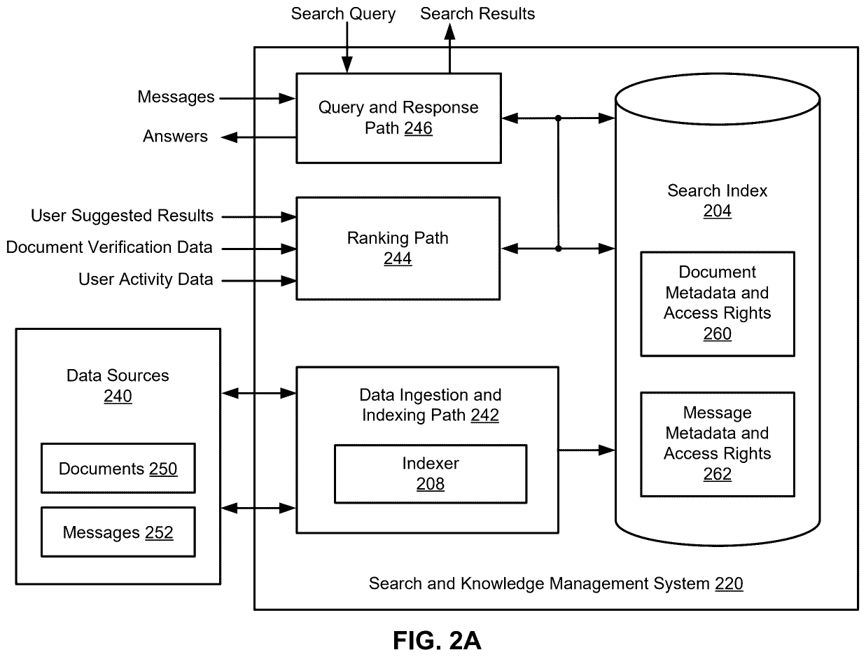

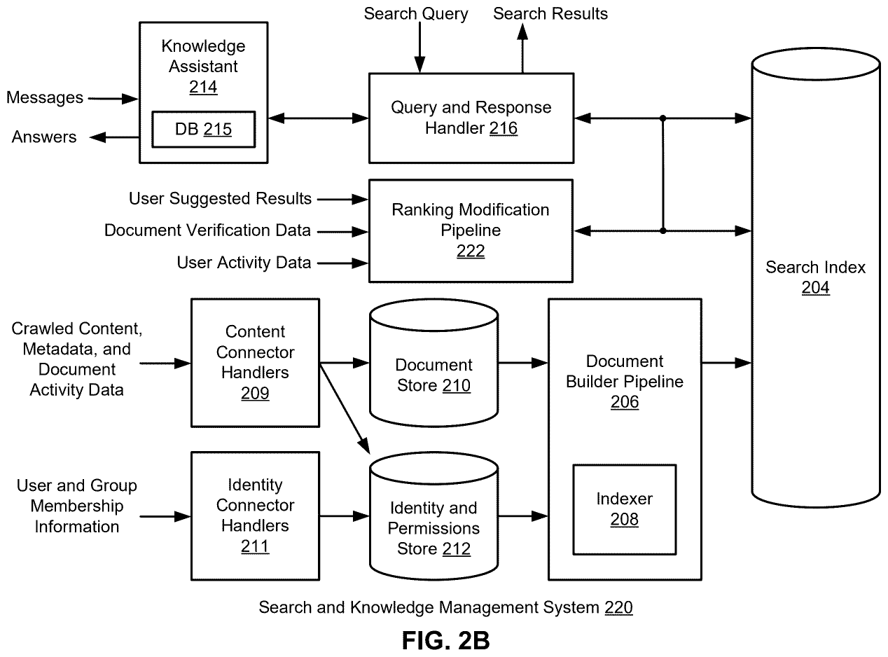

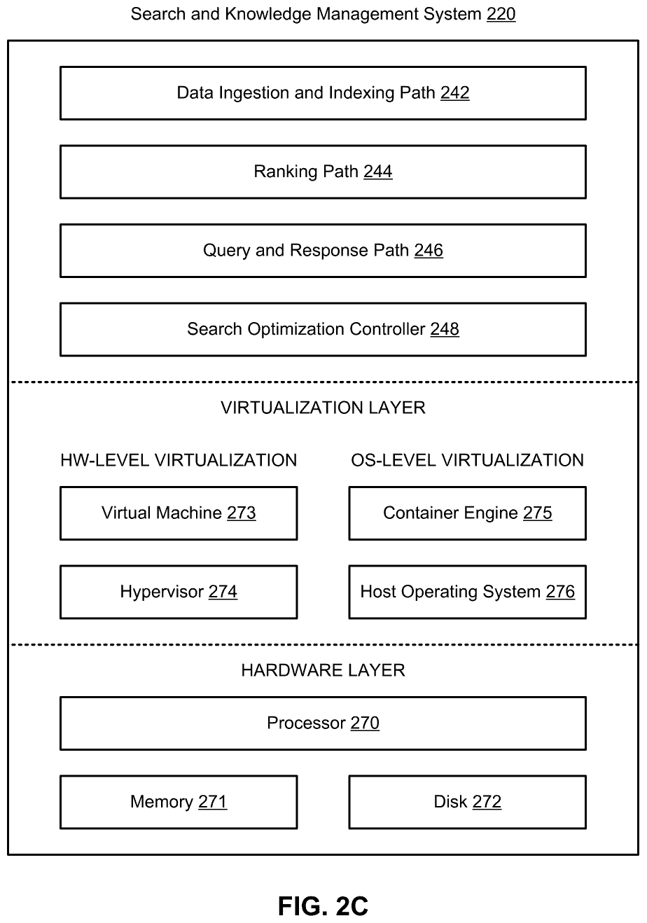

Technology is described for generating and displaying clustered search results and contextual recommendations. Contextual recommendations (or in-context recommendations) may comprise recommendations that are automatically generated and displayed without an explicit search query being entered or submitted by a user of a search system, such as the search and knowledge management system 120 depicted in FIG. 1 or the search and knowledge management system 220 in FIG. 2C. The contextual recommendations may be automatically generated and displayed to provide the user with supplemental content and supplemental context related to an electronic document or application into which the user is inserting content or information (e.g., adding or modifying text) without requiring the user to initiate an explicit search (e.g., via submission of a search query). The supplemental content may comprise portions of search result documents that are retrieved from a search system based on content inserted into the electronic document or application by the user. The supplemental context may comprise document context, such as an identification of where each search result document was sourced or mentioned (e.g., that a particular search result document originated from a chat message, an email, or from a particular website). The supplemental context may also include an identification that the supplemental content was verified and a user identifier associated with the verified content.

In some cases, while the user is making edits to an electronic document or within an application in real-time (e.g., while the user is editing a word processing document, writing code, or creating a support ticket), the search system identifies a set of search terms based on information entered by the user and/or the locations of the information entered by the user within the electronic document or application and then generates and displays search results based on the set of search terms. In one example, the set of search terms may comprise one or more sentences that were written or edited within a past threshold period of time (e.g., within the past two minutes) by the user. In another example, the set of search terms may correspond with a past number of words (e.g., the last ten words) that were written or edited by the user within the electronic document or application. In another example, the set of search terms may correspond with a sentence or a paragraph corresponding to an insertion point for inserting information into the electronic document or application. In another example, the set of search terms may correspond to both a first sentence (or a portion thereof) preceding an insertion point and a second sentence (or a portion thereof) after the insertion point within the electronic document or application.

The search system may generate contextual recommendations by submitting a search query that includes the identified set of search terms and/or other contents of the electronic document or the application in response to a search triggering event. In one example, the search triggering event includes detection that the set of search terms comprise search terms that have been searched by other users (e.g., by at least two other users) of the search system when viewing or inserting content into the electronic document or application. In another example, the search triggering event is triggered based upon detection that similar searches for the set of search terms have been performed by others or the user within a past threshold period of time (e.g., by at least two other users within the past 48 hours). In another example, the search triggering event includes detection that a particular number of search queries from other users have been initiated when viewing or inserting content into the electronic document or application at a particular location (e.g., when an insertion or edit was made within a particular paragraph or sentence of the electronic document). Moreover, a user may explicitly cause contextual recommendations to be generated and displayed by submitting a search query or initiating a search action via an explicit search command (e.g., by entering a keyboard command such a command-J or control-J). The contextual recommendations may be displayed or surfaced as clickable recommendations for related or relevant content in a companion window.

In some cases, search results are intelligently clustered to improve the ability for users to access information and relevant content from search results that have a high degree of similarity. Search result documents that are deemed similar (e.g., that have a high similarity score for their content or that have similar document titles) may be clustered together when search results are displayed to the user. The ranking of results within a cluster of search results may be determined based on document search rankings, the last edit dates for the search results in the cluster, and/or the creation dates of documents associated with the search results in the cluster. The number of clustered search results in the cluster that are displayed may be set or adjusted depending on the total number of search result documents that are deemed similar. The search result documents may correspond with electronic messages, such as chat messages within a chat channel, email messages, online text messages, instant messages, and/or electronic messages associated with a speech to text meeting transcript.

A technical benefit of identifying search results that have a high degree of similarity and then displaying different clusters of the search results is that users may scan through multiple clusters of content more efficiently to identify desired content. After a cluster of search result documents has been identified, a summary of the contents of the cluster may be generated using a generative model and the summary may be displayed along with links to a subset of the highest ranking search result documents within the cluster. In one example, a first cluster may correspond with access log files involving a first username and a second cluster may correspond with access log files involving a second username. A first summary of the contents of the first cluster may be generated and displayed along with references or links to a subset of the access log files involving the first username. The first summary may provide full referenceability with links to the source information contained within the access log files involving the first username.

Technology is also described for allowing users of the search system to specify and use personalized Uniform Resource Locator (URL) keyword links to access computing devices, services, and documents using a network connection. A URL keyword link (or keyword link) may be used to map a long and complicated URL into one or more shorter and easier to remember keywords. The search system may return URL keyword links as search results for a given search query even if a document or resource referenced by the URL keyword link has not been indexed or crawled. To identify an appropriate URL keyword link as a search result, the search system make take into consideration a username for a search query, the text used for the URL keyword link itself, the text used as context around the URL keyword link if the URL keyword link was referenced in a chat message or electronic document, the text used in the URL string that the keyword link maps to, and the text used by other URL keyword links (e.g., URL keyword links created by other users) that map to the same URL string as the URL keyword link. The search system may utilize a directory or table to store URL keyword link to URL string mappings.

A URL keyword link to URL string mapping may be assigned to a particular group (e.g., apply to every user assigned to the particular group) or assigned to a particular user (e.g., only apply to the particular user). Allowing URL keyword link to URL string mappings to be set on a per user basis allows different users to map the same URL keyword link to different URL strings. As the URL keyword link to URL string mappings may vary per group (or subgroup) and per individual user, the URL keyword link returned as a search result will depend on the user specifying a search query. In one example, a first user may specify that a keyword link “goto/roadmap” maps to a first URL string for an engineering roadmap document while a second user may specify that the same keyword link “goto/roadmap” maps to a second URL string for a sales roadmap document different from the engineering roadmap document.

The technical benefits of generating and displaying multiple clusters of search results based on search result similarity and utilizing user-specific and/or group-specific keyword link to URL strings mappings is that search system performance may be improved, the amount of time required for users to find relevant information may be reduced, and the energy consumption and cost of computing resources necessary to provide relevant search results may be reduced.

A permissions-aware search and knowledge management system may enable digital content (or content) stored across a variety of local and cloud-based data stores to be indexed, searched, and displayed to authorized users. The searchable content may comprise data or text embedded within electronic documents, hypertext documents, text documents, web pages, electronic messages, instant messages, database fields, digital images, and wikis. An enterprise or organization may restrict access to the digital content over time by dynamically restricting access to different sets of data to different groups of people using access control lists (ACLs) or authorization lists that specify which users or groups of users of the permissions-aware search and knowledge management system may access, view, or alter particular sets of data. A user of the permissions-aware search and knowledge management system may be identified via a unique username or a unique alphanumeric identifier. In some cases, an email address or a hash of the email address for the user may be used as the primary identifier for the user. To determine whether a user executing a search query has sufficient access rights to view particular search results, the permissions-aware search and knowledge management system may determine the access rights via ACLs for sets of data (e.g., for multiple electronic documents) underlying the particular search results at the time that the search is executed by the user or prior to the display of the particular search results to the user (e.g., the access rights may have been set when the sets of data underlying the particular search results were indexed).

To determine the most relevant search results for the user's search query, the permissions-aware search and knowledge management system may identify a number of relevant documents within a search index for the searchable content that satisfy the user's search query. The relevant documents (or items) may then be ranked by determining an ordering of the relevant documents from the most relevant document to the least relevant document. A document may comprise any piece of digital content that can be indexed, such as an electronic message or a hypertext document. A variety of different ranking signals or ranking factors may be used to rank the relevant documents for the user's search query. In some embodiments, the identification and ranking of the relevant documents for the user's search query may take into account user suggested results from the user and/or other users (e.g., from co-workers within the same group as the user or co-located at the same level within a management hierarchy), the amount of time that has elapsed since a user suggested result was established, whether the underlying content was verified by a content owner of the content as being up-to-date or approved content, the amount of time that has elapsed since the underlying content was verified by the content owner, and the recent activity of the user and/or related group members (e.g., a co-worker within the same group as the user recently discussed a particular subject related to the executed search query within a messaging application within the past week).

The permissions-aware search and knowledge management system may allow a user to search for content and resources across different workplace applications and data sources that are authorized to be viewed by the user. The permissions-aware search and knowledge management system may include a data ingestion and indexing path that periodically acquires content and identity information from different data sources and then adds them to a search index. The data sources may include databases, file systems, document management systems, cloud-based file synchronization and storage services, cloud-based applications, electronic messaging applications, and workplace collaboration applications. In some cases, data updates and new content may be pushed to the data ingestion and indexing path. In other cases, the data ingestion and indexing path may utilize a site crawler or periodically poll the data sources for new, updated, and deleted content. As the content from different data sources may contain different data formats and document types, incoming documents may be converted to plain text or to a normalized data format. The search index may include portions of text, text summaries, unique words, terms, and term frequency information per indexed document. In some cases, the text summaries may only be provided for documents that are frequently searched or accessed. A text summary may include the most relevant sentences, key words, personal names, and locations that are extracted from a document using natural language processing (NLP). The permissions-aware search and knowledge management system may utilize NLP and deep-learning models in order to identify semantic meaning within documents and search queries.

The permissions-aware search and knowledge management system may generate and display relevant answers to search queries (e.g., natural language search queries) explicitly submitted by the user or inferred from the viewing and editing behavior of the user within an electronic document or application. The search and knowledge management system may utilize generative machine learning models to understand content, context, and permissions from across an organization including working relationships between individuals within the organization, internal language, and security parameters. The working relationships between individuals within the organization, internal language that is unique to the organization, and organization specific security parameters may be determined using an organization specific knowledge graph that represents organization specific content, individuals, and activity within an organization, along with how each piece of information relates to one another. The nodes of the knowledge graph may correspond with contents (e.g., documents, messages, and tickets), individuals (e.g., usernames, identities and roles, team and group assignments), and activities (e.g., user viewing, editing, data sharing, and usage patterns). The edges of the knowledge graph may correspond with document-document interactions (or document linkages) in which one document references another document, user-user interactions in which one user has interacted or collaborated with another user (e.g., via an exchange of electronic messages), and user-document-interactions in which a user has created, edited, shared, or commented on a document.

FIG. 1 depicts one embodiment of a networked computing environment 100 in which the disclosed technology may be practiced. The networked computing environment 100 includes a search and knowledge management system 120, one or more data sources 140, server 160, and a computing device 154 in communication with each other via one or more networks 180. The networked computing environment 100 may include a plurality of computing devices interconnected through one or more networks 180. The networked computing environment 100 may correspond with or provide access to a cloud computing environment providing Software-as-a-Service (SaaS) or Infrastructure-as-a-Service (IaaS) services. The one or more networks 180 may allow computing devices and/or storage devices to connect to and communicate with other computing devices and/or other storage devices. In some cases, the networked computing environment 100 may include other computing devices and/or other storage devices not shown. The other computing devices may include, for example, a mobile computing device, a non-mobile computing device, a server, a workstation, a laptop computer, a tablet computer, a desktop computer, or an information processing system. The other storage devices may include, for example, a storage area network storage device, a networked-attached storage device, a hard disk drive, a solid-state drive, a data storage system, or a cloud-based data storage system. The one or more networks 180 may include a cellular network, a mobile network, a wireless network, a wired network, a secure network such as an enterprise private network, an unsecure network such as a wireless open network, a local area network (LAN), a wide area network (WAN), the Internet, or a combination of networks.

In some embodiments, the computing devices within the networked computing environment 100 may comprise real hardware computing devices or virtual computing devices, such as one or more virtual machines. The storage devices within the networked computing environment 100 may comprise real hardware storage devices or virtual storage devices, such as one or more virtual disks. The real hardware storage devices may include non-volatile and volatile storage devices.

The search and knowledge management system 120 may comprise a permissions-aware search and knowledge management system that utilizes user suggested results, document verification, and user activity tracking to generate or rank search results. The search and knowledge management system 120 may enable content stored in storage devices throughout the networked computing environment 100 to be indexed, searched, and displayed to authorized users. The search and knowledge management system 120 may index content stored on various computing and storage devices, such as data sources 140 and server 160, and allow a computing device, such as computing device 154, to input or submit a search query for the content and receive authorized search results with links or references to portions of the content. As the search query is being typed or entered into a search bar on the computing device, potential additional search terms may be displayed to help guide a user of the computing device to enter a more refined search query. This autocomplete assistance may display potential word completions and potential phrase completions within the search bar.

As depicted in FIG. 1, the search and knowledge management system 120 includes a knowledge graph 124, network interface 125, processor 126, memory 127, and disk 128 all in communication with each other. The network interface 125, processor 126, memory 127, and disk 128 may comprise real components or virtualized components. In one example, the network interface 125, processor 126, memory 127, and disk 128 may be provided by a virtualized infrastructure or a cloud-based infrastructure. Network interface 125 allows the search and knowledge management system 120 to connect to one or more networks 180. Network interface 125 may include a wireless network interface and/or a wired network interface. Processor 126 allows the search and knowledge management system 120 to execute computer readable instructions stored in memory 127 in order to perform processes described herein. Processor 126 may include one or more processing units, such as one or more CPUs and/or one or more GPUs. Memory 127 may comprise one or more types of memory (e.g., RAM, SRAM, DRAM, EEPROM, Flash, etc.). Disk 128 may include a hard disk drive and/or a solid-state drive. Memory 127 and disk 128 may comprise hardware storage devices.

The knowledge graph 124 may be stored using a hardware storage device or within a data storage layer. The nodes of the knowledge graph may correspond with contents of electronic documents, user identifiers associated with different users, and user activities (e.g., user viewing, editing, data sharing, and usage patterns). The edges of the knowledge graph may correspond with document-document interactions in which one document references another document, user-user interactions in which one user has interacted or collaborated with another user, and user-document-interactions in which a user has created, edited, shared, or commented on a document.

In one embodiment, the search and knowledge management system 120 may include one or more hardware processors and/or one or more control circuits for performing a permissions-aware search in which a ranking of search results is outputted or displayed in response to a search query. The search results may be displayed using snippets or summaries of the content. In some embodiments, the search and knowledge management system 120 may be implemented using a cloud-based computing platform or cloud-based computing and data storage services.

The data sources 140 include collaboration and communication tools 141, file storage and synchronization services 142, issue tracking tools 143, databases 144, and electronic files 145. The data sources 140 may include a communication platform not depicted that provides online chat, threaded conversations, videoconferencing, file storage, and application integration. The data sources 140 may comprise software and/or hardware used by an organization to store its data. The data sources 140 may store content that is directly searchable, such as text within text files, word processing documents, presentation slides, and spreadsheets. For audio files or audiovisual content, the audio portion may be converted to searchable text using an audio to text converter or transcription application. For image files and videos, text within the images may be identified and extracted to provide searchable text. The collaboration and communication tools 141 may include applications and services for enabling communication between group members and managing group activities, such as electronic messaging applications, electronic calendars, and wikis or hypertext publications that may be collaboratively edited and managed by the group members. The electronic messaging applications may provide persistent chat channels that are organized by topics or groups. The collaboration and communication tools 141 may also include distributed version control and source code management tools. The file storage and synchronization services 142 may allow users to store files locally or in the cloud and synchronize or share the files across multiple devices and platforms. The issue tracking tools 143 may include applications for tracking and coordinating product issues, bugs, and feature requests. The databases 144 may include distributed databases, relational databases, and NoSQL databases. The electronic files 145 may comprise text files, audio files, image files, video files, database files, electronic message files, executable files, source code files, spreadsheet files, and electronic documents that allow text and images to be displayed consistently independent of application software or hardware.

The computing device 154 may comprise a mobile computing device, such as a tablet computer, that allows a user to access a graphical user interface for the search and knowledge management system 120. A search interface may be provided by the search and knowledge management system 120 to search content within the data sources 140. A search application identifier may be included with every search to preserve contextual information associated with each search. The contextual information may include the data sources and search rankings that were used for the search using the search interface.

A server, such as server 160, may allow a client device, such as the computing device 154, to download information or files (e.g., executable, text, application, audio, image, or video files) from the server or to enable a search query related to particular information stored on the server to be performed. The search results may be provided to the client device by a search engine or a search system, such as the search and knowledge management system 120. The server 160 may comprise a hardware server. In some cases, the server may act as an application server or a file server. In general, a server may refer to a hardware device that acts as the host in a client-server relationship or to a software process that shares a resource with or performs work for one or more clients. The server 160 includes a network interface 165, processor 166, memory 167, and disk 168 all in communication with each other. Network interface 165 allows server 160 to connect to one or more networks 180. Network interface 165 may include a wireless network interface and/or a wired network interface. Processor 166 allows server 160 to execute computer readable instructions stored in memory 167 in order to perform processes described herein. Processor 166 may include one or more processing units, such as one or more CPUs and/or one or more GPUs. Memory 167 may comprise one or more types of memory (e.g., RAM, SRAM, DRAM, EEPROM, Flash, etc.). Disk 168 may include a hard disk drive and/or a solid-state drive. Memory 167 and disk 168 may comprise hardware storage devices.

The networked computing environment 100 may provide a cloud computing environment for one or more computing devices. In one embodiment, the networked computing environment 100 may include a virtualized infrastructure that provides software, data processing, and/or data storage services to end users accessing the services via the networked computing environment. In one example, networked computing environment 100 may provide cloud-based work productivity applications to computing devices, such as computing device 154. The networked computing environment 100 may provide access to protected resources (e.g., networks, servers, storage devices, files, and computing applications) based on access rights (e.g., read, write, create, delete, or execute rights) that are tailored to particular users of the computing environment (e.g., a particular employee or a group of users that are identified as belonging to a particular group or classification).

In some embodiments, the search and knowledge management system 120 may utilize processes that crawl the data sources 140 to identify and extract searchable content. The content crawlers may extract content on a periodic basis from files, websites, and databases and then cause portions of the content to be transferred to the search and knowledge management system 120. The frequency at which the content crawlers extract content may vary depending on the data source and the type of data being extracted. For example, a first update frequency (e.g., every hour) at which presentation slides or text files with infrequent updates are crawled may be less than a second update frequency (e.g., every minute) at which some websites or blogging services that publish frequent updates to content are crawled. In some cases, files, websites, and databases that are frequently searched or that frequently appear in search results may be crawled at the second update frequency (e.g., every two minutes) while other documents that have not appeared in search results within the past two days may be crawled at the first update frequency (e.g., once every two hours). The content extracted from the data sources 140 may be used to build a search index using portions of the content or summaries of the content. The search and knowledge management system 120 may extract metadata associated with various files and include the metadata within the search index. The search and knowledge management system 120 may also store user and group permissions within the search index. The user permissions for a document with an entry in the search index may be determined at the time of a search query or at the time that the document was indexed. A document may represent a single object that is an item in the search index, such as a file, folder, or a database record.

After the search index has been created and stored, then search queries may be accepted and ranked search results to the search queries may be generated and displayed. Only documents that are authorized to be accessed by a user may be returned and displayed. The user may be identified based on a username or email address associated with the user. The search and knowledge management system 120 may acquire one or more ACLs or determine access permissions for the documents underlying the ranked search results from the search index that includes the access permissions for the documents. The search and knowledge management system 120 may process a search query by passing over the search index and identifying content information that matches the search terms of the search query and synonyms for the search terms. The content associated with the matched search terms may then be ranked taking into account user suggested results from the user and others, whether the underlying content was verified by a content owner within a past threshold period of time (e.g., was verified within the past week), and recent messaging activity by the user and others within a common grouping. The authorized search results may be displayed with links to the underlying content or as part of personalized recommendations for the user (e.g., displaying an assigned task or a highly viewed document by others within the same group).

To generate the search index, a full crawl in which the entire content from a data source is fetched may be performed upon system initialization or whenever a new data source is added. In some cases, registered applications may push data updates; however, because the data updates may not be complete, additional full crawls may be performed on a periodic basis (e.g., every two weeks) to make sure that all data changes to content within the data sources are covered and included within the search index. In some cases, the rate of the full crawl refreshes may be adjusted based on the number of data update errors detected. A data update error may occur when documents associated with search results are out of date due to content updates or when documents associated with search results have had content changes that were not reflected in the search index at the time that the search was performed. Each data source may have a different full crawl refresh rate. In one example, full crawls on a database may be performed at a first crawl refresh rate and full crawls on files associated with a website may be performed at a second crawl refresh rate greater than the first crawl refresh rate.

An incremental crawl may fetch only content that was modified, added, or deleted since a particular time (e.g., since the last full crawl or since the last incremental crawl was performed). In some cases, incremental crawls or the fetching of only a subset of the documents from a data source may be performed at a higher refresh rate (e.g., every hour) on the most searched documents or for documents that have been flagged as having a at least a threshold number of data update errors, or that have been newly added to the organization's corpus that are searchable. In other cases, incremental crawls may be performed at a higher refresh rate (e.g., content changes are fetched every ten minutes) on a first set of documents within a data source in which content deletion occurs at a first deletion rate (e.g., some content is deleted at least every hour) and performed at a lower refresh rate (e.g., content changes are fetched every hour) on a second set of documents within the data source in which content deletion occurs at a second deletion rate (e.g., content deletions occur on a weekly basis). One technical benefit of performing incremental crawls on a subset of documents within a data source that comprise frequently searched documents or documents that have a high rate of data deletions is that the load on the data source may be reduced and the number of application programming interface (API) calls to the data source may be reduced.

FIG. 2A depicts one embodiment of a search and knowledge management system 220 in communication with one or more data sources 240. In one embodiment, the search and knowledge management system 220 may comprise one implementation of the search and knowledge management system 120 in FIG. 1 and the data sources 240 may correspond with the data sources 140 in FIG. 1. The data sources 240 may include one or more electronic documents 250 and one or more electronic messages 252 that are stored over various networks, document and content management systems, file servers, database systems, desktop computers, portable electronic devices, mobile phones, cloud-based applications, and cloud-based services.

The search and knowledge management system 220 may comprise a cloud-based system that includes a data ingestion and index path 242, a ranking path 244, a query and response path 246, and a search index 204. The search index 204 may store a first set of index entries for the one or more electronic documents 250 including document metadata and access rights 260 and a second set of index entries for the one or more electronic messages 252 including message metadata and access rights 262. The data ingestion and index path 242 may crawl a corpus of documents within the data sources 240, index the documents and extract metadata for each document fetched from the data sources 240, and then store the metadata in the search index 204. An indexer 208 within the data ingestion and index path 242 may write the metadata to the search index 204. In one example, if a fetched document comprises a text file, then the metadata for the document may include information regarding the file size or number of words, an identification of the author or creator of the document, when the document was created and last modified, key words from the document, a summary of the document, and access rights for the document. The query and response path 246 may receive a search query from a user computing device, such as the computing device 154 in FIG. 1, and compare the search query and terms derived from the search query (e.g., synonyms and related terms) with the search index 204 to identify relevant documents for the search query. The query and response path 246 may also include or interface with an automated digital assistant that may interact with a user of the user computing device in a conversational manner in which answers are outputted in response to messages or questions provided to the automated digital assistant.

The relevant documents may be ranked using the ranking path 244 and then a set of search results responsive to the search query may be outputted to the user computing device corresponding with the ranking or ordering of the relevant documents. The ranking path 244 may take into consideration a variety of signals to score and rank the relevant documents. The ranking path 244 may determine the ranking of the relevant documents based on the number of times that a search query term appears within the content or metadata for a document, whether the search query term matches a key word for a document, and how recently a document was created or last modified. The ranking path 244 may also determine the ranking of the relevant documents based on user suggested results from an owner of a relevant document or the user executing the search query, the amount of time that has passed since the user suggested result was established, whether a document was verified by a content owner, the amount of time that has passed since the relevant document was verified by the content owner, and the amount and type of activity performed with a past period of time (e.g., within the past hour) by the user executing the search query and related group members.

FIG. 2B depicts one embodiment of the search and knowledge management system 220 of FIG. 2A. The search and knowledge management system 220 may comprise a cloud-based system that includes a data ingestion and indexing path, a ranking path, a query path, and a search index 204. The components of the search and knowledge management system 220 may be implemented using software, hardware, or a combination of hardware and software. In some cases, a cloud-based task service for asynchronous execution, cloud-based task handlers, or a cloud-based system for managing the execution, dispatch, and delivery of distributed tasks may be used to implement the fetching and processing of content from various data sources, such as data sources 240 in FIG. 2A. In some cases, a cloud-based task service or a cloud-based system for managing the execution, dispatch, and delivery of distributed tasks may be used to acquire and synchronize user and group identifications associated with content fetched from the various data sources. The data sources may have dedicated task queues or shared task queues depending on the size of the data source and the rate requirements for fetching the content. In one example, a data source may have a dedicated task queue if the data source stores more than a threshold number of documents or more than a threshold amount of content (e.g., stores more than 100 GB of data).

The data ingestion and indexing path is responsible for periodically acquiring content and identity information from the data sources 240 in FIG. 2A and adding the content and identity information or portions thereof to the search index 204. The data ingestion and indexing path includes content connector handlers 209 in communication with document store 210. The document store 210 may comprise a key value store database or a cloud-based database service. The content connector handlers 209 may comprise software programs or applications that are used to traverse and fetch content from one or more data sources. The content connector handlers 209 may make API calls to various data sources, such as the data sources 240 in FIG. 2A, to fetch content and data updates from the data sources. Each data source may be associated with one content connector for that data source. The content connector handlers 209 may acquire content, metadata, and activity data corresponding with the content. For example, the content connector handlers 209 may acquire the text of a word processing document, metadata for the word processing document, and activity data for the word processing document. The metadata for the word processing document may include an identification of the owner of the document, a timestamp associated with when the document was last modified, a file size for the document, and access permissions for the document. The activity data for the word processing document may include the number of views for the document within a threshold period of time (e.g., within the past week or since the last update to the document occurred), the number of likes for the document, the number of downloads for the document, and the number of shares associated with the document. The content connector handlers 209 may store the fetched content, metadata, and activity data in the document store 210 and publish the fetch event to a publish-subscribe (pubsub) system not depicted so that the document builder pipeline 206 may be notified that the fetch event has occurred. In response to the notification, the document builder pipeline 206 may process the fetched content and add the fetched content and information derived from the fetched content to the search index 204. The document builder pipeline 206 may transform or augment the fetched content prior to storing the information derived from the fetched content in the search index 204. In one example, the document builder pipeline 206 may augment the fetched content with identity information and synonyms.

Some data sources may utilize APIs that provide notification (e.g., via webhook pings) to the content connector handlers 209 that content within a data source has been modified, added, or deleted. For data sources that are not able to provide notification that content updates have occurred or that cannot push content changes to the content connector handlers 209, the content connector handlers 209 may perform periodic incremental crawls in order to identify and acquire content changes. In some cases, the content connector handlers 209 may perform periodic incremental crawls or full crawls even if a data source has provided webhook pings in the past in order to ensure the integrity of the acquired content and that the search and knowledge management system 220 is consistent with the actual state of the content stored in the data source. Some data sources may allow applications to register for callbacks or push notifications whenever content or identity information has been updated at the data source.

As depicted in FIG. 2B, the data ingestion and indexing path also includes identity connector handlers 211 in communication with identity and permissions store 212. The identity and permissions store 212 may comprise a key value store database or a cloud-based database service. The identity connector handlers 211 may acquire user and group membership information from one or more data sources and store the user and group membership information in the identity and permissions store 212 to enable search results that respect data source specific privacy settings for the content stored using the one or more data sources. The user information may include data source specific user information, such as a data source specific user identification or username. The identity connector handlers 211 may comprise software programs or applications that are used to acquire and synchronize user and/or group identities to a primary identity used by the search and knowledge management system 220 to uniquely identify a user. Each user of the search and knowledge management system 220 may be canonically represented via a unique primary identity, which may comprise a hash of an email address for the user. In some cases, the search and knowledge management system 220 may map an email address that is used as the primary identity for a user to an alphanumeric username used by a data source to identify the same user. In other cases, the search and knowledge management system 220 may map a unique alphanumeric username that is used as the primary identity for a user to two different usernames that are used by a data source to identify the same user, such as one username associated with regular access permissions and another username associated with administrative access permissions. If a data source does not identify a user by the user's primary identity within the search and knowledge management system 220, then an external identity that identifies the user for that data source may be determined by the search and knowledge management system 220 and mapped to the primary identity.

In some cases, the content connector handlers 209 may fetch access rights and permissions settings associated with the fetched content during the content crawl and store the access rights and permission settings using the identity and permissions store 212. For some data sources, the identity crawl to obtain user and group membership information may be performed before the content crawl to obtain content associated with the user and group membership information. When a document is fetched during the content crawl, the content connector handlers 209 may also fetch the ACL for the document. The ACL may specify the allowed users with the ability to view or access the document, the disallowed users that do not have access rights to view or access the document, allowed groups with the ability to view or access the document, and disallowed groups that do not have access rights to view or access the document. The ACL for the document may indicate access privileges for the document including which individuals or groups have read access to the document.

In some cases, a particular set of data may be associated with an ACL that determines which users within an organization may access the particular set of data. In one example, to ensure compliance with data security and retention regulations, the particular set of data may comprise sensitive or confidential information that is restricted to viewing by only a first group of users. In another example, the particular set of data may comprise source code and technical documentation for a particular product that is restricted to viewing by only a second group of users.

As depicted in FIG. 2B, the document store 210 may store crawled content from various data sources, along with any transformation or processing of the content that occurs prior to indexing the crawled content. Every piece of content acquired from the data sources may correspond with a row in the document store 210. For example, when the content connector handlers 209 fetch a spreadsheet or word processing document from a data source, the raw content for the spreadsheet or word processing document may be stored as a row in the document store 210. In addition to the raw content, a row in the document store 210 may also include interaction or activity data associated with the content, such as the number of views, the number of comments, the number of likes, and the number of users who interacted with the content along with their corresponding user identifications. A row in the document store 210 may also include document metadata for the stored content, such as keywords or classification information, and permissions or access rights information for the stored content.

The identity and permissions store 212 may store the primary identity for a user (e.g., a hash of an email address) within the search and knowledge management system 220 and corresponding usernames or data source identifiers used by each data source for the same user. A row in the identity and permissions store 212 may include a mapping from the user identifier used by a data source to the corresponding primary identity for the user for the search and knowledge management system 220. The identity and permissions store 212 may also store identifications for each user assigned to a particular group or associated with a particular group membership. The ACLs that are associated with a fetched document may include allowed user identifications and allowed group identifications. Each user of the search and knowledge management system 220 may correspond with a unique primary identity and each primary identity may be mapped to all groups that the user is a member of across all data sources.

As depicted in FIG. 2B, the data ingestion and indexing path includes document builder pipeline 206 in communication with search index 204. The document builder pipeline 206 may comprise software programs or applications that are used to transform or augment the crawled content to generate searchable documents that are then stored within the search index 204. The document builder pipeline 206 may include an indexer 208 that writes content derived from the fetched content, structured metadata for the fetched content, and access rights for the fetched content to the search index 204.

The searchable documents generated by the document builder pipeline 206 may comprise portions of the crawled content along with augmented data, such as access right information, document linking information, search term synonyms, and document activity information. In one example, the document builder pipeline 206 may transform the crawled content by extracting plain text from a word processing document, a hypertext markup language (HTML) document, or a portable document format (PDF) document and then directing the indexer 208 to write the plain text for the document to the search index 204. A document parser may be used to extract the plain text for the document or to generate clean text for the document that can be indexed (e.g., with HTML tags or text formatting tags removed). The document builder pipeline 206 may also determine access rights for the document and write the identifications for the users and groups with access rights to the document to the search index 204. The document builder pipeline 206 may determine document linking information for the crawled document, such as a list of all the documents that reference the crawled document and their anchor descriptions, and store the document linking information in the search index 204. The document linking information may be used to determine document popularity (e.g., based on how many times a document is referenced or the number of outlinks from the document) and preserve searchable anchor text for target documents that are referenced. The words or terms used to describe an outgoing link in a source document may provide an important ranking signal for the linked target document if the words or terms accurately describe the target document. The document builder pipeline 206 may also determine document activity information for the crawled document, such as the number of document views, the number of comments or replies associated with the document, and the number of likes or shares associated with the document, and store the document activity information in the search index 204.

The document builder pipeline 206 may be subscribed to publish-subscribe events that get written by the content connector handlers 209 every time new documents or updates are added to the document store 210. Upon notification that the new documents or updates have been added to the document store 210, the document builder pipeline 206 may perform processes to transform or augment the new documents or portions thereof prior to generating the searchable documents to be stored within the search index 204.

As depicted in FIG. 2B, the query path includes a query and response handler 216 in communication with the search index 204 and the ranking modification pipeline 222. A knowledge assistant 214 interacts with the query and response handler 216 to provide a real-time automated digital assistant that may interact with a user of the search and knowledge management system 220 via a graphical user interface in a conversational manner using natural language dialog. The automated digital assistant may comprise a computer-implemented assistant that may access and display only information that a user's access rights permit. The knowledge assistant 214 may include a frequently asked questions (FAQ) database that includes question and answer pairs for questions identified within a chat channel that were classified as factual questions. The FAQ database may be stored in database DB 215 or in a solid-state memory not depicted.

The query and response handler 216 may comprise software programs or applications that detect that a search query has been submitted by an authenticated user identity, parse the search query, acquire query metadata for the search query, identify a primary identity for the authenticated user identity, acquire ranked search results that satisfy the search query using the primary identity and the parsed search query, and output (e.g., transfer or display) the ranked search results that satisfy the search query or that comprise the highest ranking of relevant information for the search query and the query metadata. The search query may be parsed by acquiring an inputted search query string for the search query and identifying root terms or tokenized terms within the search query string, such as unigrams and bigrams, with corresponding weights and synonyms. In some cases, natural language processing algorithms may be used to identify terms within a search query string for the search query. The search query may be received as a string of characters and the natural language processing algorithms may identify a set of terms (or a set of tokens) from the string of characters. Potential spelling errors for the identified terms may be detected and corrected terms may be added or substituted for the potentially misspelled terms.

The query metadata may include synonyms for terms identified within the search query and nearest neighbors with semantic similarity (e.g., with semantic similarity scores above a threshold that indicate their similarity to each other at the semantic level). The semantic similarity between two texts (e.g., each comprising one or more words) may refer to how similar the two texts are in meaning. A supervised machine learning approach may be used to determine the semantic similarity between the two texts in which training data for the supervised step may include sentence or phrase pairs and the associated labels that represent the semantic similarly between the sentence or phrase pairs. The query and response handler 216 may consume the search query as a search query string, and then construct and issue a set of queries related to the search query based on the terms identified within the search query string and the query metadata. In response to the set of queries being issued, the query and response handler 216 may acquire a set of relevant documents for the set of queries from the search index 204. The set of relevant documents may be provided to the ranking modification pipeline 222 to be scored and ranked for relevance to the search query. After the set of relevant documents have been ranked, a subset of the set of relevant documents may be identified (e.g., the top thirty ranked documents) based on the ranking and summary information or snippets may be acquired from the search index 204 for each document of the subset of the set of relevant documents. The query and response handler 216 may output the ranked subset of the set of relevant documents and their corresponding snippets to a computing device used by the authenticated user, such as the computing device 154 in FIG. 1.

Moreover, when a user issues a search query, the query and response handler 216 may determine the primary identity for the authenticated user and then query the identity and permissions store 212 to acquire all groups that the user is a member of across all data sources. The query and response handler 216 may then query the search index 204 with a filter that restricts the retrieved set of relevant documents such that the ACLs for the retrieved documents permit the user to access or view each of the retrieved set of relevant documents. In this case, each ACL should either specify that the user comprises an allowed user or that the user is a member of an allowed group.

The search index 204 may comprise a database that stores searchable content related to documents stored within the data sources 240 in FIG. 2A. The search index 204 may store text, title strings, chat message bodies, metadata, and access rights related to searchable content. For each searchable document, portions of text associated with the document, extracted key words, document classifications, and document summaries may be stored within the search index 204. For searchable electronic messages (e.g., searchable chat messages or email messages), the title, the message body of the original message, and the message bodies of related messages may be stored within the search index 204. For searchable question and answer responses, the message body of the question and the message body of the answer may be stored within the search index 204. A question and answer pair may derive from questions and answers made by the user or made by other users (e.g., co-workers) during a conversation exchange within a persistent chat channel or from dialog between an artificial intelligence powered digital assistant and the user within a chat channel. One example of an artificial intelligence powered digital assistant is the knowledge assistant 214 that may automatically output answers to messages or questions provided to the digital assistant. Text associated with other documents linked to or referenced by a searchable document, electronic message, or question and answer pair may also be stored within the search index 204 to provide context for the searchable content. Content access rights including which users and groups are allowed to access the content may be stored within the search index 204 for each piece of searchable content.

As depicted in FIG. 2B, the ranking modification pipeline 222 may comprise software programs or applications that are used to score and rank documents and portions of documents. The scoring of a set of relevant documents may weight different attributes of the documents differently. In one example, literal matches or lexical matches of search query terms within the body of a message or document may correspond with a first weighting while semantic matches of the search query terms may correspond with a second weighting different from the first weighting (e.g., greater than the first weighting). The matching of search query terms or their synonyms within a message body may be given a first weighting while the matching of the search query terms within a title field or within the text of a referencing document (e.g., anchor text within a source document) may be given a second weighting different from the first weighting (e.g., greater than the first weighting). The scoring and ranking of a set of relevant documents may take into consideration document popularity, which may change over time as a document ages or as the number of views for a document within a past period of time (e.g., within the past week) increases or decreases. A higher document popularity score may increase the ranking of a document, while a lower document popularity score may signal that the document has become stale and that its importance should be demoted. The ranking modification pipeline 222 may score and rank a set of relevant documents based on user suggested results submitted by owners of the relevant documents, the document verification statuses of the relevant documents, and the amount and type of user activity performed within a past period of time (e.g., within the past 24 hours) by the user executing a search query and others that are part of a common grouping with the user (e.g., co-workers on the same team or assigned to the same group).

FIG. 2C depicts one embodiment of various components of the search and knowledge management system 220 of FIG. 2A. As depicted, the search and knowledge management system 220 includes hardware-level components and software-level components. The hardware-level components may include one or more processors 270, one or more memory 271, and one or more disks 272. The one or more memory 271 and the one or more disks 272 may comprise storage devices or hardware storage devices. The software-level components may include software applications and computer programs. In some embodiments, the data ingestion and index path 242, the ranking path 244, the query and response path 246, and the search optimization controller 248 may be implemented using software or a combination of hardware and software. In some cases, the software-level components may be run using a dedicated hardware server. In other cases, the software-level components may be run using a virtual machine or containerized environment running on a plurality of machines. In various embodiments, the software-level components may be run from the cloud (e.g., the software-level components may be deployed using a cloud-based compute and storage infrastructure).

As depicted in FIG. 2C, the software-level components may also include virtualization layer processes, such as virtual machine 273, hypervisor 274, container engine 275, and host operating system 276. The hypervisor 274 may comprise a native hypervisor (or bare-metal hypervisor) or a hosted hypervisor (or type 2 hypervisor). The hypervisor 274 may provide a virtual operating platform for running one or more virtual machines, such as virtual machine 273. A hypervisor may comprise software that creates and runs virtual machine instances. Virtual machine 273 may include a plurality of virtual hardware devices, such as a virtual processor, a virtual memory, and a virtual disk. The virtual machine 273 may include a guest operating system that has the capability to run one or more software applications, such as applications for the data ingestion and index path 242, the ranking path 244, and the query and response path 246. The virtual machine 273 may run the host operation system 276 upon which the container engine 275 may run.

A container engine 275 may run on top of the host operating system 276 in order to run multiple isolated instances (or containers) on the same operating system kernel of the host operating system 276. Containers may facilitate virtualization at the operating system level and may provide a virtualized environment for running applications and their dependencies. Containerized applications may comprise applications that run within an isolated runtime environment (or container). The container engine 275 may acquire a container image and convert the container image into running processes. In some cases, the container engine 275 may group containers that make up an application into logical units (or pods). A pod may contain one or more containers and all containers in a pod may run on the same node in a cluster. Each pod may serve as a deployment unit for the cluster. Each pod may run a single instance of an application.

The search optimization controller 248 may automatically generate and display clustered search results and contextual recommendations. The contextual recommendations may provide both supplemental content and supplemental context related to an electronic document or application into which a user is inserting content or information without requiring the user to initiate an explicit search. While the user is making edits to an electronic document or within an application in real-time, the search optimization controller 248 may identify a set of search terms based on information entered by the user and/or the locations of the information entered by the user within the electronic document or application and then generate and display search results based on the set of search terms. The search optimization controller 248 may generate and display the contextual recommendations in response to a search triggering event. The search optimization controller 248 may cluster search results or search result documents that have a degree of similarity and display multiple clusters of search results to the user. The results within a cluster of search results may be ranked and/or ordered based on document search rankings, the last edit dates for the search results in the cluster, and/or the creation dates of documents associated with the search results in the cluster. Moreover, a summary of the contents within the search results of a cluster may be generated by the search optimization controller 248 using a generative model and the summary may be displayed along with links to a subset of the search results within the cluster.

The search optimization controller 248 may also enable the return of URL keyword links as search results for a given search query even if a document or resource referenced by the URL keyword link has not been indexed or crawled. To identify an appropriate URL keyword link as a search result, the search optimization controller 248 make take into consideration a username associated with a user entering a search query, the text used for the URL keyword link itself, the text used as context around the URL keyword link if the URL keyword link was referenced in a chat message or electronic document, the text used in the URL string that the keyword link maps to, and the text used by other URL keyword links that map to the same URL string as the URL keyword link.

The search optimization controller 248 may store or access one or more large language models. A large language model (LLM) refers to a language model that comprises a neural network with a large number of parameters (e.g., millions or billions of parameters or weights). In order to reduce training time and cost, transfer learning can be utilized in which a pre-trained model is used as a starting point for a specific task and then trained or fine-tuned with a supervised dataset for the specific task. In one example, an LLM is pre-trained using a large dataset and then fine-tuned using a much smaller dataset to tailor the LLM to solve a specific task. Pretraining refers to the act of training a machine learning model from scratch without any prior knowledge using a large corpus of data. Fine-tuning refers to a transfer learning process that modifies a pretrained LLM by training the LLM in a supervised or semi-supervised manner. In some cases, the fine-tuning involves adapting a pretrained LLM for a specific task by fine-tuning the LLM using a task specific dataset.

In some cases, an LLM comprises a transformer model that is implemented using a transformer-based neural network architecture. A transformer model includes an encoder and/or a decoder. An encoder extracts features from an input sequence and a decoder uses the extracted features from the encoder to produce an output sequence. In some cases, an encoder comprises one or more encoding layers and a decoder comprises one or more decoding layers. Each encoding and decoding layer includes a self-attention mechanism that relates tokens within a sequence of tokens to other tokens within the sequence. In one example, the self-attention mechanism allows the transformer model to examine a word within a sentence and determine the relative importance of other words within the same sentence to the examined word. In some cases, an encoder includes a self-attention layer and a feed forward neural network layer and a decoder includes two self-attention layers and a feed forward neural network layer. In some cases, a transformer model (or transformer) utilizes an encoder-decoder architecture, an encoder only architecture, or a decoder only architecture.

One example of a transformer model is a Generative Pre-trained Transformer (GPT) model. A GPT model comprises a type of LLM that uses deep learning to generate human-like text. A GPT model is referred to as being “generative” because it generates new content based on a given input prompt (e.g., a text prompt), “pre-trained” because it is trained on a large corpus of data before being fine-tuned for specific tasks, and a “transformer” because it utilizes a transformer-based neural network architecture to process the input prompt to generate the output content (or response).

In some cases, Retrieval Augmented Generation (RAG) may be used to improve the search quality and accuracy of LLMs for search-related tasks (e.g., question answering tasks) by first retrieving relevant documents from a search index based on an input search query prior to using an LLM to generate an output or answer. Moreover, the LLM for generating the output or answer will only be able to access content within the relevant documents that is accessible by a user providing the input search query, thereby improving data security.

Multimodal learning refers to a type of machine learning in which a machine learning model is trained to understand multiple forms of input data (e.g., text, images, video, and audio data) that derive from different modalities. Image data can include different types of images, such as color images, depth images, and thermal images. In some cases, a machine learning model comprises a multimodal model, a language model, or a visual model.

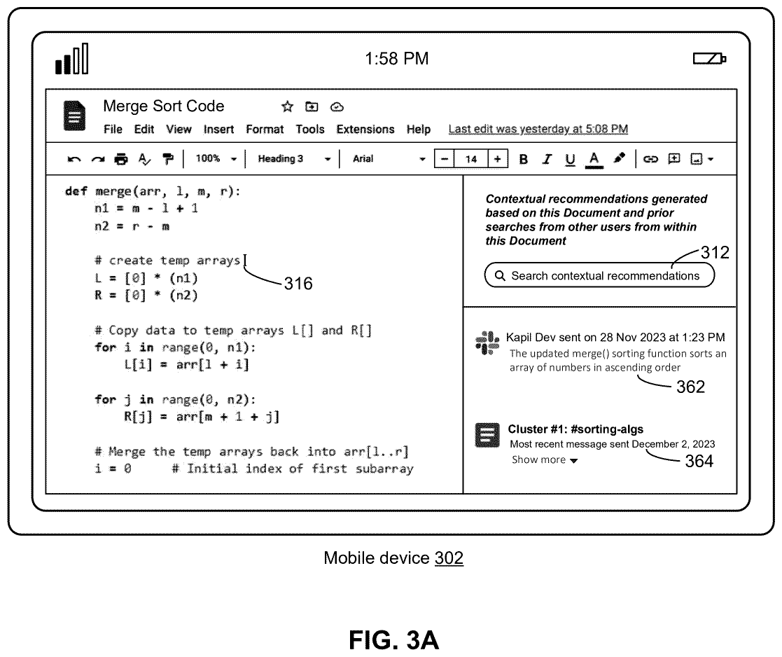

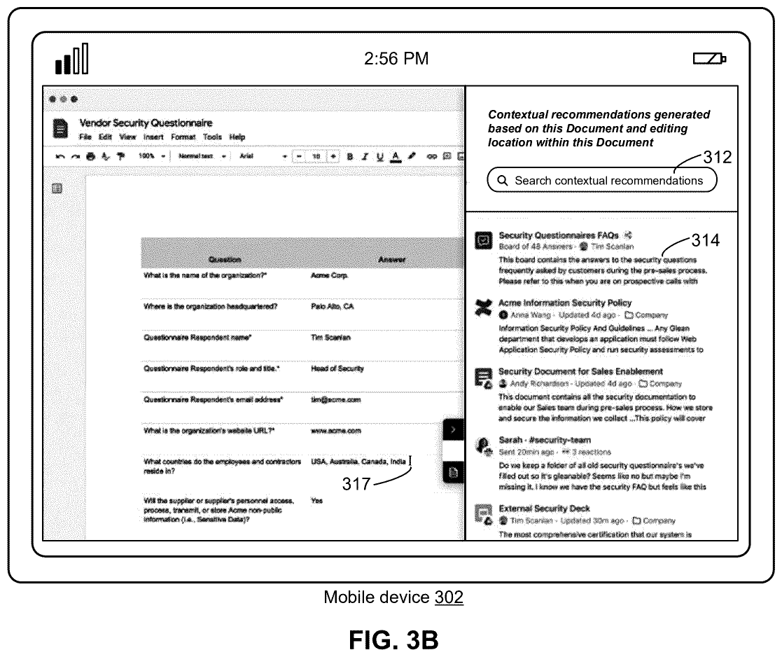

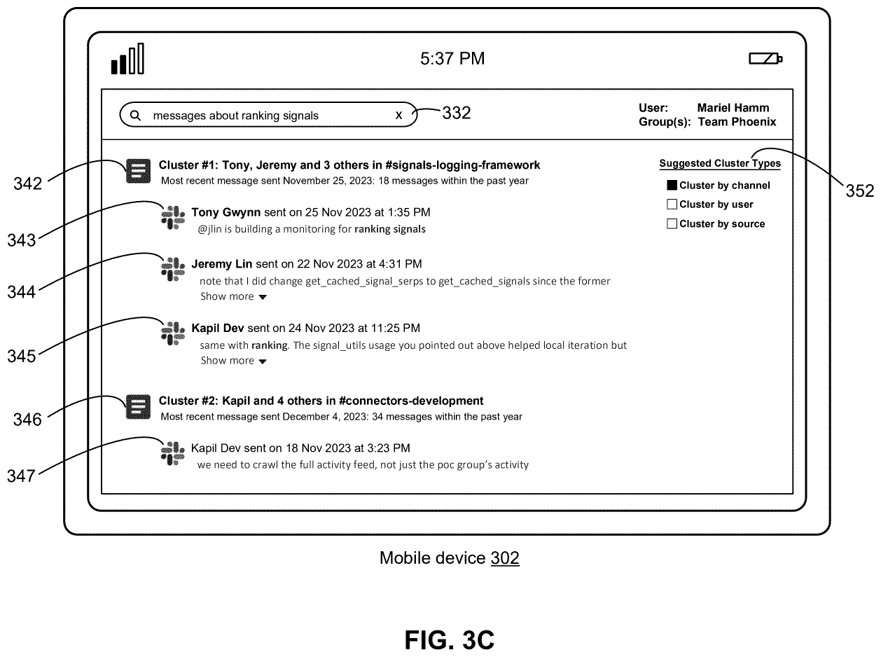

FIG. 3A depicts one embodiment of a mobile device 302 providing a user interface for interacting with a permissions-aware search and knowledge management system, such as the search and knowledge management system 120 in FIG. 1. The mobile device 302 may correspond with the computing device 154 in FIG. 1. As depicted, as an end user of the mobile device 302 is editing source code associated with a function at an insertion location 316, contextual recommendations 362 and 364 are automatically generated and displayed. The contextual recommendation 364 may comprise a cluster of search results. A search bar 312 is also displayed to allow the end user to search the contextual recommendations 362 and 364. In one embodiment, search terms associated with a first number of sentences prior to the insertion location 316 and a second number of sentences after the insertion location 316 are used as a search query for generating the contextual recommendations 362 and 364. In another embodiment, search terms associated with a first number of characters prior to the insertion location 316 and a second number of characters after the insertion location 316 are used as a search query for generating the contextual recommendations 362 and 364.

FIG. 3B depicts another embodiment of the mobile device 302 providing a user interface for interacting with a permissions-aware search and knowledge management system. As depicted, as an end user of the mobile device 302 is viewing or editing an electronic document at a location 317, contextual recommendations including contextual recommendation 314 are automatically generated and displayed. A search bar 312 is also displayed to allow the end user to search the contextual recommendations. In one embodiment, search terms associated with content from a row or paragraph that includes the location 17 is used as a search query for generating the contextual recommendation 314.

FIG. 3C depicts one embodiment of a mobile device 302 providing a user interface for interacting with a permissions-aware search and knowledge management system, such as the search and knowledge management system 120 in FIG. 1. As depicted, a search query “messages about ranking signals” has been submitted via the search bar 332 and clustered search results including a first cluster 342 comprising search results 343-345 and a second cluster 346 including search result 347 have been generated and displayed. Suggested cluster types 352 may be selected to generate clusters based on channels, users, and/or sources. As the “cluster by channel” option has been selected, the first cluster 342 includes search results corresponding to the channel #signals-logging-framework and the second cluster 346 includes search results corresponding to the channel #connectors-development. In some cases, each cluster of search results may comprise a set of search results with at least a threshold degree of similarity with respect to content within the set of search results. Each search result of a set of search results for a cluster may belong to the same cluster type. In one example, each search result in a first cluster may be generated from the same channel. In another example, each search result in a first cluster may be generated from content associated with a particular user identifier.

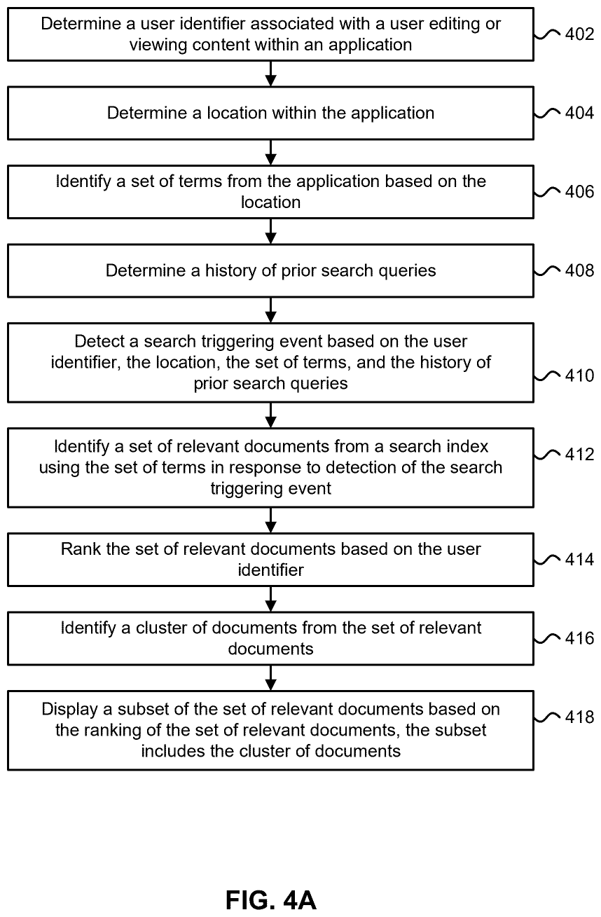

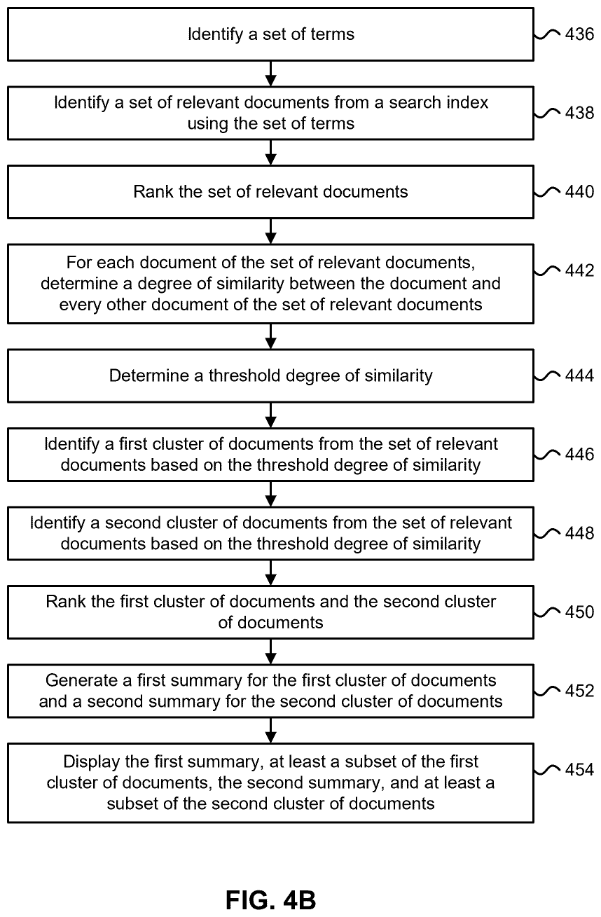

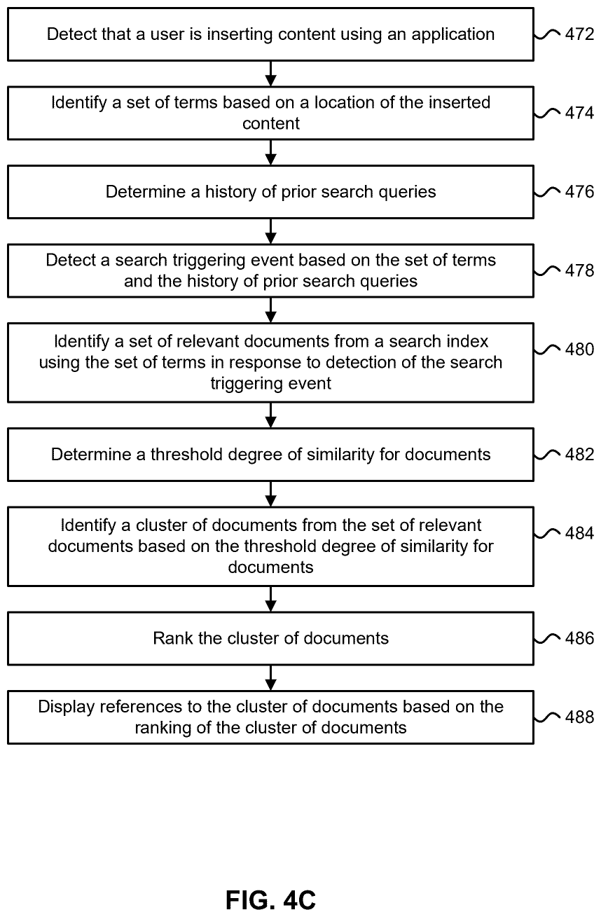

FIG. 4A depicts a flowchart describing one embodiment of a process for generating contextual recommendations that include clustered search results. In one embodiment, the process of FIG. 4A may be performed by a search and knowledge management system, such as the search and knowledge management system 120 in FIG. 1 or the search and knowledge management system 220 in FIG. 2A. In another embodiment, the process of FIG. 4A may be implemented using a cloud-based computing platform or cloud-based computing services.

In step 402, a user identifier associated with a user editing or viewing content within an application is determined. As examples, the application may comprise a computing application, a software application, a web application, a web browser, a word processing application, or an application for developing software. The user identifier may comprise a unique username or a unique alphanumeric identifier. In step 404, a location within the application is determined. The location may correspond with a user editing location or a user viewing location within the application. In one example, the location corresponds to the location 317 in FIG. 3B. In step 406, a set of terms (or set of search terms) from the application is identified based on the location. In some cases, the set of terms comprise a sentence or a portion of a paragraph corresponding to the location. The set of terms may correspond to both a first sentence (or a portion thereof) preceding the location and a second sentence (or a portion thereof) after the location. The set of terms may also include content that was inserted into the application within a past threshold period of time (e.g., within the past minute) and that is located within a threshold distance of the location within the application.

In step 408, a history of prior search queries is determined. The history of prior search queries may correspond to search queries that were previously submitted by other users of a search system. The history of prior search queries may also correspond to search queries that were previously submitted by other users of the application. In step 410, a search triggering event is detected based on the user identifier, the location, the set of terms, and/or the history of prior search queries. In one example, the search triggering event may comprise detection that the set of terms comprises search terms that have been searched by other users based on the history of prior search queries. In another example, the search triggering event may comprise detection that the set of terms comprises one or more search terms that have been searched by other users based on the history of prior search queries within a past threshold period of time (e.g., within the past 48 hours). In another example, the search triggering event includes detection that at least a particular number of search queries from other users have been initiated when viewing or inserting content into an electronic document at the location. The search triggering event may occur when the set of terms identified in step 406 comprise high frequency search terms that are used by other users of a search system or by other users of the application. In one example, if the set of terms matches search terms that have been used by other users of a search system or by other users of the application (e.g., the other users have explicitly entered search queriers that include the set of terms), then a search triggering event may occur.

In step 412, a set of relevant documents is identified from a search index using the set of terms in response to detection of the search triggering event. The search index may correspond with the search index 204 in FIG. 2A. In step 414, the set of relevant documents is ranked based on the user identifier. The set of relevant documents may comprise electronic documents that are accessible by the user identifier. In step 416, a cluster of documents is identified from the set of relevant documents. One example of a process for generating one or more clusters of documents is depicted in reference to FIG. 4B. In step 418, a subset of the set of relevant documents is displayed based on the ranking of the set of relevant documents. The subset of the set of relevant documents includes the cluster of documents. In some cases, the cluster of documents may comprise ten electronic documents that are displayed in order of a ranking or score for each of the electronic documents within the cluster.

FIG. 4B depicts a flowchart describing one embodiment of a process for generating clustered search results. In one embodiment, the process of FIG. 4B may be performed by a search and knowledge management system, such as the search and knowledge management system 120 in FIG. 1 or the search and knowledge management system 220 in FIG. 2B. In another embodiment, the process of FIG. 4B may be implemented using a cloud-based computing platform or cloud-based computing services. The process depicted in FIG. 4B is one example of a process for implementing step 416 in FIG. 4A.

In step 436, a set of terms is identified. The set of terms may comprise a set of search terms associated with a search query. The set of terms may be identified via entry into a search bar. In step 438, a set of relevant documents is identified from a search index using the set of terms. The set of relevant documents may comprise searchable documents within a search index with at least a threshold relevance score or at least a threshold number of matching terms from the set of terms (e.g., at least two terms within the set of terms are found in each of the set of relevant documents). The relevance score may be calculated for each indexed document within the search index using a number of factors or criteria, such as the presence of one or more terms from the set of terms within a title or summary of an indexed document, how recently an indexed document was updated and whether one or more terms of the set of terms were added within a particular period of time (e.g., a searched term was added within the past week), the term frequency or the number of times that one or more terms from the set of terms appears within an indexed document, the source rating for an indexed document (e.g., a word processing document or presentation slides may have a higher source rating than an electronic message), and a term proximity for the set of terms within an indexed document.

In step 440, the set of relevant documents is ranked. The set of relevant documents may be ranked based on scores generated by a ranking pipeline, such as the ranking modification pipeline 222 in FIG. 2B or the ranking path 244 in FIG. 2A. In step 442, for each document of the set of relevant documents, a degree of similarity is determined between the document and every other document of the set of relevant documents.

A degree of similarity between two documents (or portions thereof) may be computed using a similarity function, such as cosine similarity. Embeddings may be generated for each document of the set of relevant documents and the embeddings may be compared or used to compute the degree of similarity. If the similarity of the embeddings based on a cosine similarity is greater than a threshold degree of similarity, then two documents may be deemed to be sufficiently similar to be placed into a cluster of documents.

In step 444, a threshold degree of similarity is determined. In step 446, a first cluster of documents from the set of relevant documents is identified based on the threshold degree of similarity. In one example, if the threshold degree of similarity is equal to 0.9, then documents within the set of relevant documents that have a degree of similarity greater than the threshold degree of similarity with a reference document may be placed into the first cluster of documents. The reference document may comprise a seed document for the first cluster or the highest scoring document within the set of relevant documents.

In step 448, a second cluster of documents from the set of relevant documents is identified based on the threshold degree of similarity. The first cluster of documents may be identified based on a degree of similarity between a first reference document and other documents within the set of relevant documents and the second cluster of documents may be identified based on a degree of similarity between a second reference document and other documents within the set of relevant documents. The first reference document may comprise the highest scoring document within the set of relevant documents and the second reference document may comprise the highest scoring document after the documents of the first cluster have been removed from the set of relevant documents.

In step 450, the first cluster of documents and the second cluster of documents are ranked. Each document within the first cluster of documents may be ordered based on a ranking of the documents within the first cluster. Each document within the second cluster of documents may be ordered based on a ranking of the documents within the second cluster. The ranking of documents may take into account when the documents were last edited and when the documents were created, with more recent edits boosting rankings.

In step 452, a first summary for the first cluster of documents and a second summary for the second cluster of documents are generated. The first summary and the second summary may be generated using generative models. In step 454, the first summary is displayed along with at least a subset of the first cluster of documents and the second summary is displayed along with at least a subset of the second cluster of documents. The summaries and snippets of the documents for the first and second clusters may be displayed using a display of a computing device, such as the computing device 154 in FIG. 1.

FIG. 4C depicts a flowchart describing one embodiment of a process for automatically generating and displaying clustered search results and contextual recommendations. In one embodiment, the process of FIG. 4C may be performed by a search and knowledge management system, such as the search and knowledge management system 120 in FIG. 1 or the search and knowledge management system 220 in FIG. 2B. In another embodiment, the process of FIG. 4C may be implemented using a cloud-based computing platform or cloud-based computing services.

In step 472, it is detected that a user of an application is inserting content using the application. In step 474, a set of terms is identified based on a location of the insert content. In one example, the set of terms comprise a set of words that intersect with the location of the inserted content. In another example, the set of terms corresponds with a sentence at the location. In step 476, a history of prior search queries is determined. In step 478, a search triggering event is detected based on the set of terms and the history of prior search queries. In step 480, a set of relevant documents is identified from a search index using the set of terms in response to detection of the search triggering event. In step 482, a threshold degree of similarity for documents is determined. In step 484, a cluster of documents from the set of relevant documents is identified based on the threshold degree of similarity for documents. In step 486, the cluster of documents is ranked. In step 488, references or links to the cluster of documents are displayed based on the ranking of the cluster of documents.

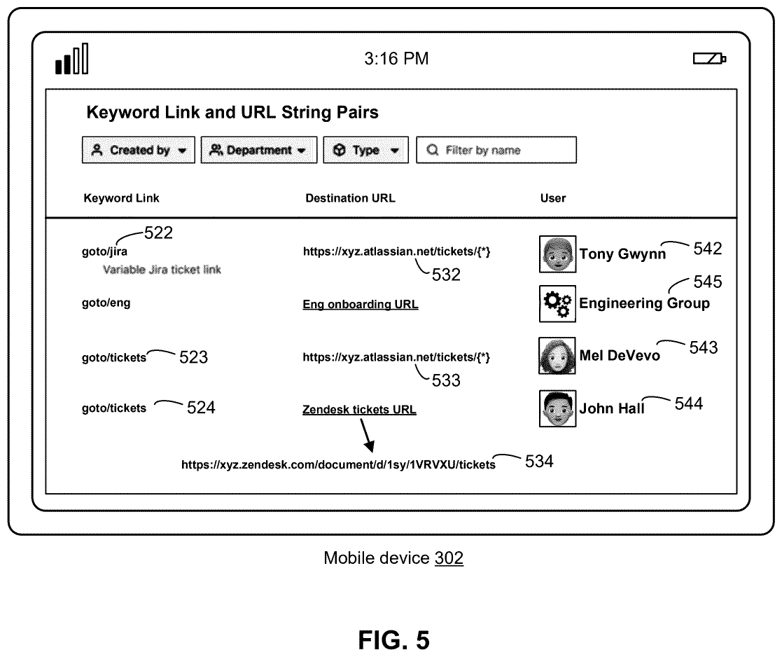

FIG. 5 depicts one embodiment of a mobile device 302 providing a user interface for interacting with a permissions-aware search and knowledge management system, such as the search and knowledge management system 120 in FIG. 1, to create, store, and utilize keyword link and URL string pairs. The mobile device 302 may correspond with the computing device 154 in FIG. 1. Keyword link and URL string pairs may be stored in a database or table. As depicted, keyword link 522 comprising “goto/jira” and URL string 532 comprise a first keyword link and URL string pair that has been created by the user 542. The keyword link 523 comprising “goto/tickets” and URL string 533 comprise a second keyword link and URL string pair that has been created by the user 543. The keyword link 524 comprising “goto/tickets” and URL string 534 comprise a third keyword link and URL string pair that has been created by the user 544. Keyword link and URL string pairs may be created by individual users and by groups, such as the engineering group 545. The keyword link and URL string pairs created for a group may apply to every individual user assigned to that group. The keyword link 522 and URL string 532 comprises a variable pair, in which the URL string includes a base URL and a variable symbol.

Each user may create a unique keyword link and URL string pair. This means that different users may create keyword link and URL string pairs in which the same keyword link (e.g., comprising “goto/tickets”) may map to different URL strings. As depicted in FIG. 5, the keyword link 524 and the keyword link 523 comprise the same keyword link “goto/tickets,” but have been created by different users. The keyword link 523 maps to a different URL string than the keyword link 524. Different keyword links may map to the same URL string. For example, the keyword link 522 comprising “goto/jira” and the keyword link 523 comprising “goto/tickets” both map to the same URL string comprising “https://xyz.atlassian.net/tickets/{*}.”

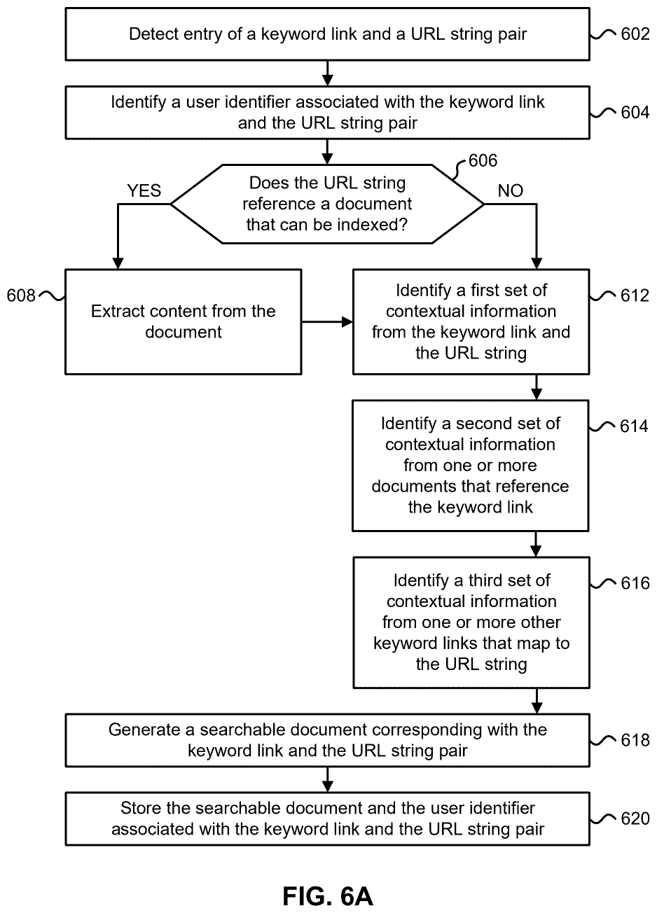

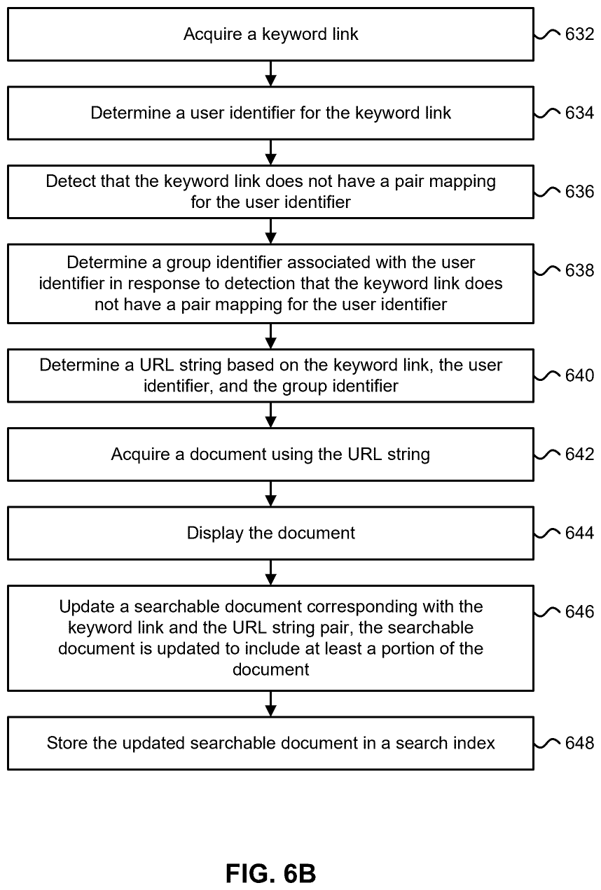

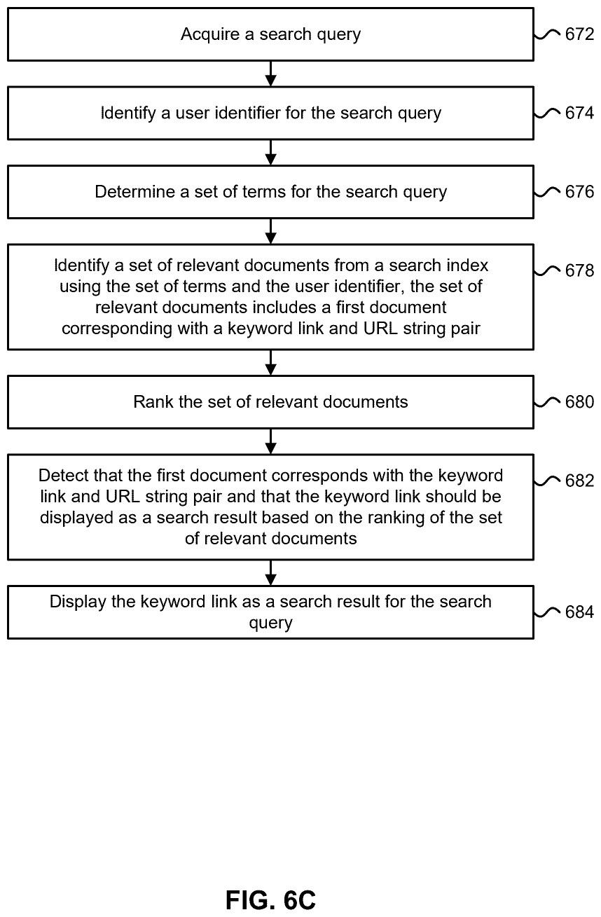

FIG. 6A depicts a flowchart describing one embodiment of a process for generating and storing keyword link and URL string pairs. In one embodiment, the process of FIG. 6A may be performed by a search and knowledge management system, such as the search and knowledge management system 120 in FIG. 1 or the search and knowledge management system 220 in FIG. 2B. In another embodiment, the process of FIG. 6A may be implemented using a cloud-based computing platform or cloud-based computing services.

In step 602, entry of a keyword link and URL string pair is detected. The entry of the keyword link and the corresponding URL string may be detected when a user of a search and knowledge management system enters the keyword link and the corresponding URL string into a database or table. The user may create an entry for the keyword link and the corresponding URL string using a user interface for a mobile computing device, such as the mobile device 302 in FIG. 5. In step 604, a user identifier associated with the keyword link and the URL string pair is identified. In one example, in reference to FIG. 5, the keyword link 522 and URL string 532 pair has been created by the user 542. The user identifier may uniquely identify a user of the search and knowledge management system.

In step 606, it is determined whether the URL string references a document that can be indexed. In one example, if the URL string comprises a link or path to a document that can be accessed or downloaded by a search and knowledge management system, then the document can be indexed by the search and knowledge management system. If the document cannot be crawled or indexed by the search and knowledge management system, then a speculative model of the document may be generated and stored. The speculative model may include the text used for the keyword link itself, the text used as context around the keyword link if the keyword link was referenced in a chat message or electronic document, the text used in the URL string that the keyword link maps to, and the text used by other keyword links (e.g., keyword links created by other users) that map to the same URL string as the keyword link.

If the URL string references a document that can be indexed or is accessible for indexing, then step 608 is performed. Otherwise, if the URL string references a document that cannot be indexed or is not accessible for indexing, then step 612 is performed.

In step 608, content is extracted from the document. The content extracted from the document may be stored in a search index, such as the search index 204 in FIG. 2A. After step 608 is performed, then step 612 is performed.

In step 612, a first set of contextual information is identified from the keyword link and the URL string. The first set of contextual information may include the text of the keyword link and/or the text of the URL string. In step 614, a second set of contextual information is identified from one or more documents that reference the keyword link. In this case, the second set of contextual information may include text found in electronic documents and electronic messages that reference the keyword link. In one example, a chat message may reference the keyword link and the second set of contextual information may include the contents of the chat message. In step 616, a third set of contextual information is identified from one or more other keyword links that map to the URL string. In one example, in reference to FIG. 5, both the keyword link 522 and the keyword link 523 map to the same URL string and therefore the third set of contextual information may include both the text string “goto/jira” and the text string “goto/tickets.”

In step 618, a searchable document corresponding with the keyword link and the URL string pair is generated. The searchable document may include the first set of contextual information, the second set of contextual information, and/or the third set of contextual information. In step 620, the searchable document and the user identifier associated with the keyword link and the URL string pair are stored. The searchable document and the user identifier associated with the keyword link and the URL string pair may be stored within a search index, such as the search index 204 in FIG. 2A.

FIG. 6B depicts a flowchart describing one embodiment of a process for utilizing keyword link and URL string pairs. In one embodiment, the process of FIG. 6B may be performed by a search and knowledge management system, such as the search and knowledge management system 120 in FIG. 1 or the search and knowledge management system 220 in FIG. 2B. In another embodiment, the process of FIG. 6B may be implemented using a cloud-based computing platform or cloud-based computing services.

In step 632, a keyword link is acquired. The keyword link may be acquired from a web browser or a search bar into which a user of a search and knowledge management system has entered the keyword link. In step 634, a user identifier for the keyword link is determined. The user identifier may uniquely identify the user who entered the keyword link into a search bar. In step 636, it is detected that the keyword link does not have a pair mapping for the user identifier. In this case, a user associated with the user identifier may not have created a keyword link and URL string pair for the entered keyword link. In step 638, a group identifier associated with the user identifier is determined in response to detection that the keyword link does not have a pair mapping for the user identifier. In this case, keyword link and URL string pairs belonging to individual users may be given priority over pairs created by groups. If an individual has not created a particular keyword link and URL string pair, then keyword link and URL string pairs that one or more groups to which the user has been assigned may be considered.

In step 640, a URL string is determined based on the keyword link, the user identifier, and the group identifier. The URL string may be determined via a lookup table or from a database given the user identifier, the group identifier, and the keyword link as inputs. In one example, in reference to FIG. 5, the URL string given a user identifier for the user 542 and the keyword link 522 would be the URL string 532. In step 642, a document is acquired using the URL string. A DNS client may be used to convert a URL associated with the URL string into a corresponding IP address for accessing the document. In step 644, the document is displayed. In step 646, a searchable document corresponding with the keyword link and the URL string pair is updated. The searchable document may be updated to include at least a portion of the document acquired in step 642. In step 648, the updated searchable document is stored in a search index, Such as the search index 204 in FIG. 2A.

FIG. 6C depicts a flowchart describing one embodiment of a process for generating and displaying a keyword link as a search result. The keyword link may be returned as a search result for a given search query even though a document referenced by the URL string that is paired with the keyword link is not accessible and/or has not been indexed. In one embodiment, the process of FIG. 6C may be performed by a search and knowledge management system, such as the search and knowledge management system 120 in FIG. 1 or the search and knowledge management system 220 in FIG. 2B. In another embodiment, the process of FIG. 6C may be implemented using a cloud-based computing platform or cloud-based computing services.

In step 672, a search query is acquired. In step 674, a user identifier for the search query is identified. In step 676, a set of terms for the search query is determined. In step 678, a set of relevant documents is identified from a search index using the set of terms and the user identifier. Each document of the set of relevant documents may be accessible by a user associated with the user identifier. The set of relevant documents includes a first document (or searchable document) corresponding with a keyword link and URL string pair. In one example, the first document was generated using step 618 in FIG. 6A for generating a searchable document corresponding to the keyword link and URL string pair. In step 680, the set of relevant documents is ranked. In step 682, it is detected that the first document corresponds with the keyword link and URL string pair and that the keyword link should be displayed as a search result based on the ranking of the set of relevant documents. In step 684, the keyword link is displayed as a search result for the search query. The keyword link may be displayed as a search result for the search query even though a document referenced by the URL string that is paired with the keyword link is not accessible and/or has not been indexed.

At least one embodiment of the disclosed technology includes detecting entry of a keyword link and a URL string pair into a database; identifying a first set of contextual information from the keyword link and the URL string; identifying a second set of contextual information from one or more documents that refer to the keyword link; identifying a third set of contextual information from a second keyword link that has been paired with the URL string in the database; generating a searchable document corresponding with the keyword link and the URL string pair; and storing the searchable document in a search index of a search system. The searchable document includes the first set of contextual information, the second set of contextual information, and the third set of contextual information.

In some cases, the method further comprises identifying a user identifier for the search query and identifying the set of relevant documents from the search index using the set of terms and the user identifier.

In some cases, the first set of contextual information includes a first text string corresponding to the keyword link and a second text string corresponding to the URL string. The second set of contextual information may include a text string from a chat message that refers to the keyword link. The third set of contextual information may include a text string corresponding to the second keyword link.

In some cases, the method further comprises identifying a group identifier associated with the keyword link and the URL string pair and storing the group identifier associated with the keyword link and the URL string pair in the search index of the search system.

At least one embodiment of the disclosed technology comprises a storage device for storing instructions that, when executed, cause a system to perform operations comprising: detecting entry of a keyword link and a URL string pair; identifying a first set of contextual information from the keyword link and the URL string; identifying a second set of contextual information from one or more documents that reference the keyword link; identifying a third set of contextual information from one or more other keyword links that map to the URL string; generating a searchable document corresponding with the keyword link and the URL string pair; and storing the searchable document in a search index of the system. The searchable document includes the first set of contextual information, the second set of contextual information, and the third set of contextual information.

In some cases, the URL string references a first document and the searchable document is generated without crawling the first document referenced by the URL string.

In some cases, the URL string references a first document and the searchable document is generated without indexing the first document.

In some cases, the system further comprises instructions that, when executed, cause the system to perform additional operations comprising: acquiring a search query; determining a set of terms for the search query; identifying a set of relevant documents from the search index using the set of terms; detecting that the keyword link should be displayed as a search result for the search query; and displaying the keyword link. The set of relevant documents includes the searchable document corresponding with the keyword link and the URL string pair.

The disclosed technology may be described in the context of computer-executable instructions being executed by a computer or processor. The computer-executable instructions may correspond with portions of computer program code, routines, programs, objects, software components, data structures, or other types of computer-related structures that may be used to perform processes using a computer. Computer program code used for implementing various operations or aspects of the disclosed technology may be developed using one or more programming languages, including an object oriented programming language such as Java or C++, a function programming language such as Lisp, a procedural programming language such as the “C” programming language or Visual Basic, or a dynamic programming language such as Python or JavaScript. In some cases, computer program code or machine-level instructions derived from the computer program code may execute entirely on an end user's computer, partly on an end user's computer, partly on an end user's computer and partly on a remote computer, or entirely on a remote computer or server.

The flowcharts and block diagrams in the figures provide illustrations of the architecture, functionality, and operation of possible implementations of systems, methods, and computer program products according to various aspects of the disclosed technology. In this regard, each step in a flowchart may correspond with a program module or portion of computer program code, which may comprise one or more computer-executable instructions for implementing the specified functionality. In some implementations, the functionality noted within a step may occur out of the order noted in the figures. For example, two steps shown in succession may, in fact, be executed substantially concurrently, or the steps may sometimes be executed in the reverse order, depending upon the functionality involved. In some implementations, steps may be omitted and other steps added without departing from the spirit and scope of the present subject matter. In some implementations, the functionality noted within a step may be implemented using hardware, software, or a combination of hardware and software. As examples, the hardware may include microcontrollers, microprocessors, field programmable gate arrays (FPGAs), and electronic circuitry.

For purposes of this document, the term “processor” may refer to a real hardware processor or a virtual processor, unless expressly stated otherwise. A virtual machine may include one or more virtual hardware devices, such as a virtual processor and a virtual memory in communication with the virtual processor.

For purposes of this document, it should be noted that the dimensions of the various features depicted in the figures may not necessarily be drawn to scale.

For purposes of this document, reference in the specification to “an embodiment,” “one embodiment,” “some embodiments,” “another embodiment,” and other variations thereof may be used to describe various features, functions, or structures that are included in at least one or more embodiments and do not necessarily refer to the same embodiment unless the context clearly dictates otherwise.

For purposes of this document, a connection may be a direct connection or an indirect connection (e.g., via another part). In some cases, when an element is referred to as being connected or coupled to another element, the element may be directly connected to the other element or indirectly connected to the other element via intervening elements. When an element is referred to as being directly connected to another element, then there are no intervening elements between the element and the other element.

For purposes of this document, the term “based on” may be read as “based at least in part on.”

For purposes of this document, without additional context, use of numerical terms such as a “first” object, a “second” object, and a “third” object may not imply an ordering of objects, but may instead be used for identification purposes to identify or distinguish separate objects.

For purposes of this document, the term “set” of objects may refer to a “set” of one or more of the objects.

For purposes of this document, the phrases “a first object corresponds with a second object” and “a first object corresponds to a second object” may refer to the first object and the second object being equivalent, analogous, or related in character or function.

For purposes of this document, the term “or” should be interpreted in the conjunctive and the disjunctive. A list of items linked with the conjunction “or” should not be read as requiring mutual exclusivity among the items, but rather should be read as “and/or” unless expressly stated otherwise. The terms “at least one,” “one or more,” and “and/or,” as used herein, are open-ended expressions that are both conjunctive and disjunctive in operation. The phrase “A and/or B” covers embodiments having element A alone, element B alone, or elements A and B taken together. The phrase “at least one of A, B, and C” covers embodiments having element A alone, element B alone, element C alone, elements A and B together, elements A and C together, elements B and C together, or elements A, B, and C together. The indefinite articles “a” and “an,” as used herein, should typically be interpreted to mean “at least one” or “one or more,” unless expressly stated otherwise.

The various embodiments described above in the Detailed Description can be combined to provide further embodiments. Aspects of the embodiments can be modified, if necessary to employ concepts of the various patents, applications and publications to provide yet further embodiments.

These and other changes can be made to the embodiments described above in the Detailed Description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system, comprising:
a storage device for storing instructions that, when executed, cause the system to perform operations comprising:
detecting entry of a keyword link and a URL string pair;
identifying a first set of contextual information from the keyword link and the URL string;
identifying a second set of contextual information from one or more documents that reference the keyword link;
identifying a third set of contextual information from one or more other keyword links that map to the URL string;
generating a searchable document corresponding with the keyword link and the URL string pair, the searchable document includes the first set of contextual information, the second set of contextual information, and the third set of contextual information; and
storing the searchable document in a search index of the system.

2. The system of claim 1, wherein:
the URL string references a first document; and
the searchable document is generated without crawling the first document referenced by the URL string.

3. The system of claim 1, wherein:
the URL string references a first document; and
the searchable document is generated without indexing the first document.

4. The system of claim 1, further comprising instructions that, when executed, cause the system to perform operations comprising:
acquiring a search query;
determining a set of terms for the search query;
identifying a set of relevant documents from the search index using the set of terms, the set of relevant documents includes the searchable document corresponding with the keyword link and the URL string pair;
detecting that the keyword link should be displayed as a search result for the search query; and
displaying the keyword link.

5. The system of claim 4, further comprising instructions that, when executed, cause the system to perform operations comprising:
identifying a user identifier for the search query; and
the identifying the set of relevant documents includes identifying the set of relevant documents from the search index using the set of terms and the user identifier.

6. The system of claim 1, wherein:
the first set of contextual information includes a first text string from the keyword link and a second text string from the URL string.

7. The system of claim 1, wherein:
the second set of contextual information includes a text string from an electronic message that references the keyword link.

8. The system of claim 1, wherein:
the third set of contextual information includes one or more text strings from one or more other keyword links that map to the URL string.

9. The system of claim 1, further comprising instructions that, when executed, cause the system to perform operations comprising:
detecting that the URL string references a first document that can be indexed; and
extracting content from the first document, the searchable document includes the extracted content from the first document.

10. The system of claim 1, further comprising instructions that, when executed, cause the system to perform operations comprising:
identifying a group identifier associated with the keyword link and the URL string pair; and
storing the group identifier associated with the keyword link and the URL string pair in the search index of the system.

11. A method for operating a search system, comprising:
detecting entry of a keyword link and a URL string pair into a database;
identifying a first set of contextual information from the keyword link and the URL string;
identifying a second set of contextual information from one or more documents that refer to the keyword link;
identifying a third set of contextual information from a second keyword link that has been paired with the URL string in the database;
generating a searchable document corresponding with the keyword link and the URL string pair, the searchable document includes the first set of contextual information, the second set of contextual information, and the third set of contextual information; and
storing the searchable document in a search index of the search system.

12. The method of claim 11, wherein:
the URL string points to a first document; and
the searchable document is generated without crawling the first document.

13. The method of claim 11, wherein:
the URL string references a first document; and
the searchable document is generated without indexing the first document.

14. The method of claim 11, further comprising:
acquiring a search query;
determining a set of terms for the search query;
identifying a set of relevant documents from the search index using the set of terms, the set of relevant documents includes the searchable document corresponding with the keyword link and the URL string pair;
ranking the set of relevant documents;
detecting that the keyword link should be displayed as a search result for the search query based on the ranking of the set of relevant documents; and
displaying the keyword link.

15. The method of claim 11, further comprising:
identifying a user identifier for the search query; and
the identifying the set of relevant documents includes identifying the set of relevant documents from the search index using the set of terms and the user identifier.

16. The method of claim 11, wherein:
the first set of contextual information includes a first text string corresponding to the keyword link and a second text string corresponding to the URL string.

17. The method of claim 11, wherein:
the second set of contextual information includes a text string from a chat message that refers to the keyword link.

18. The method of claim 11, wherein:
the third set of contextual information includes a text string corresponding to the second keyword link.

19. The method of claim 11, further comprising:
identifying a group identifier associated with the keyword link and the URL string pair; and
storing the group identifier associated with the keyword link and the URL string pair in the search index of the search system.

20. One or more storage devices containing processor readable code for configuring one or more processors to perform a method for operating a search system, wherein the processor readable code configures the one or more processors to:
acquire a keyword link and a URL string pair;
identify a first set of contextual information from the keyword link and the URL string, the first set of contextual information includes a first text string corresponding to the keyword link and a second text string corresponding to the URL string;
identify a second set of contextual information from one or more documents that refer to the keyword link;
identify a third set of contextual information from a second keyword link that has been paired with the URL string, the third set of contextual information includes a third text string corresponding to the second keyword link;
generate a searchable document corresponding with the keyword link and the URL string pair, the searchable document includes the first set of contextual information, the second set of contextual information, and the third set of contextual information; and
store the searchable document in a search index of the search system.
